(19) United States
(12) Patent Application Publication
(10) Pub. No.: US 2006/0194179 A1
(43) Pub. Date: Aug. 31, 2006

(54) Cricoid pressure training device

(76) Inventor: Mohamed Osman Abdelatti, Lancashire (GB)

Correspondence Address: MOORE & VAN ALLEN PLLC, P.O. BOX 13706, Research Triangle Park, NC, 27709, US

(21) Appl. No.: 11/067,975

(22) Filed: Feb. 28, 2005

(51) Int. Cl. G09B 23/28

(52) U.S. Cl. 434/262

(57) ABSTRACT

A device for training medical personnel the correct application of cricoid pressure/force consists of 2 boxes; one is smaller than the other. A calibrated spring is fixed inside the small box as shown in FIG. 2. A plastic numerical scale is fixed to the bottom of the small box. When manual pressure is applied on the top box the spring is compressed and the scale protrudes through an opening made in the top box. This allows the applied force or pressure to be read off the protruding scale. Alternatively, the scale could be part of the small box. A cylindrical sponge is fixed to the top box to simulate the neck and a diagram of the larynx with three finger imprints at the level of the cricoid cartilage was glued to the sponge to assist trainees to correctly locate the cricoid cartilage and apply the recommended force during training. Practice on the device is expected to allow the trainee to reproduce the correct force when this is needed to be carried out in clinical practice.

### FIELD OF THE INVENTION

This invention relates to a device for training operatives and users, and especially medical personnel and anaesthetic assistants, the correct application of cricoid pressure/force and in particular during emergency anaesthesia.

### BACKGROUND TO THE INVENTION

Cricoid pressure or force is an important technique, which is routinely used during emergency and obstetric anaesthesia. The technique involves the application of external pressure or force on the cricoid cartilage (at the front of the neck) to occlude the lumen of the oesphagus which lies behind it.

The aim of the technique is to prevent the inhalation of regurgitated stomach contents into the lungs when the patient loses consciousness at the onset of anaesthesia. The inhalation of vomit should it occur is very serious as it causes severe inflammation of the lungs and death.

The technique involves the use of three fingers; the index finger is used to apply pressure on the cricoid cartilage and the middle finger and the thumb to stabilise the larynx during the procedure. The recommended force is 30 Newtons (approximately 3 kg).

The duty and responsibility of the anaesthetist assistant is to apply this force or pressure during induction of anaesthesia until the anaesthetist secures the airway of the patient by inserting a cuffed tracheal tube in the trachea (windpipe).

An excessive force applied on the cricoid cartilage distorts the larynx and makes intubation of the trachea difficult or impossible. On the other hand, an inadequate force subjects the patient to the dangers of inhalation of stomach contents.

Several studies have shown that there is wide individual variation in the force applied with 47%-61% of the medical staff applying an inadequate force. As no suitable training device currently exists, it is necessary to provide anaesthetic assistants with a simple and readily available training tool to allow frequent training and maintain skills in order to apply cricoid pressure correctly and safely.

Although the technique will be referred to hereinafter with reference to force (as in “applied cricoid force” or ACF) it should be appreciated that the technique is also commonly referred to with reference to pressure (as in “applied cricoid pressure” or ACP). Thus, “force” as used herein is to be interpreted as encompassing “pressure” and vice versa except where such an interpretation would be contrary to the contextual meaning.

It is an aim of the present invention to overcome at least one problem associated with the prior art whether referred to herein or otherwise.

### SUMMARY OF THE INVENTION

According to a first aspect of the present invention there is provided a device for use in training an operative in the reproduction of a desired force intended to be applied to the cricoid cartilage of a patient undergoing tracheal intubation, the device comprising a simulation of at least part of a neck, the device including force measuring means for measuring the force applied to the simulated neck, the device further comprising display means to display the location of a larynx on the simulated neck, the device further comprising indication means to indicate the correct location on the simulated neck of the digits of the operative relative to the displayed larynx whilst applying the force to the cricoid cartilage.

Preferably the force measuring means comprises a first member and a second member which are connected to each other by resilient means. Preferably the resilient means comprises a spring and more preferably comprises a calibrated spring.

Preferably the resilient means locates between an inner (lower) surface of the first member and an inner (upper) surface of the second member.

Preferably either the first member or the second member includes a scale which indicates the force applied.

Preferably the scale is secured to the first (lower) member and extends upwardly and above the second (upper) member. Preferably the scale comprises an elongate member. Preferably the scale locates upwardly from an inner surface of the first member and extends through an aperture provided in the second (upper) member. Preferably the length or amount of the scale projecting above the second member indicates the force applied.

The scale may be secured to or displayed on the first (lower) member and preferably on an external side wall of the first member. Preferably a part of the second (upper) member is arranged to locate adjacent to the scale in order to indicate the force applied.

Preferably the first member and the second member form a box in which the upper surface is movable relative to the lower surface and preferably is movable against resilient means.

Preferably the first member comprises an open box member having a single open face. Preferably the second member comprises an open box member having a single open face. Preferably the second box member has a planar area greater than the planar area of the first box member and preferably enables the first box member to at least partially locate within the first box member. Preferably the open face of the second box member defines a mouth into which the open face of the first box member may locate and preferably enables the first box member to move into and out of the internal space or volume of the second box member.

Preferably the first member and/or the second member comprise a plastics.

Preferably the indication means includes a first indicator to indicate the correct position of a first digit or finger (and preferably the index finger) of the operative relative to the displayed larynx, whilst applying pressure.

Preferably the indication means includes a second indicator to indicate the correct position of a second digit or finger (and preferably the middle finger) of the operative relative to the displayed larynx, whilst applying pressure.

Preferably the indication means includes a third indicator to indicate the correct position of a third digit (and preferably the thumb) of the operative relative to the displayed larynx, whilst applying pressure.

Preferably the or each indicator comprises a visual indicator and more preferably comprises a circular mark or a finger tip/print shaped mark for each relevant digit.

Preferably the simulated neck comprises a resilient material. The simulated neck may comprise a sponge material.

Preferably the simulated neck is adhered to the upper surface of the second (upper) member and preferably is glued to the upper surface of the second (upper) member.

Preferably the device comprises a simulated cricoid cartilage. Preferably the simulated cricoid cartilage is located within the simulated neck. Preferably the simulated cricoid cartilage comprises a substantially rigid material and may comprise wood. The simulated cricoid cartilage may be adhered to the upper surface of the second (upper) member.

The simulated larynx may comprise a visual indicator of the position of the larynx on the simulated neck.

Preferably, the force measuring means comprises force display means to display the force applied. Preferably the force display means comprises a visual scale.

According to a second aspect of the present invention there is provided a method of training an operative in the technique of applied cricoid force, the method comprising providing indicator means on a simulation of part of a neck to indicate the correct position of at least one digit of the operative relative to a simulated larynx on the simulated neck whilst applying pressure, the method further comprising measuring the force applied.

According to another aspect of the present invention there is provided a simple means for training anaesthetic assistants, nurses in the intensive care units and paramedics the correct application of cricoid force/pressure. It is a simple training tool which allow medical personnel to reproduce the correct cricoid pressure/force during emergency anaesthesia and intubation after practicing on it. The device consists of 2 boxes; one is smaller than the other.

A calibrated spring is fixed inside the small box. The larger box was placed on top of the small box. When manual pressure is applied on the top box the spring is compressed and a scale protrude through an opening in the top box. This allows the applied force or pressure to be read off the protruding scale. A cylindrical sponge is fixed to the top box to simulate the feel and consistency of the neck and a diagram of the larynx was glued to the sponge to assist trainees to correctly locate the cricoid cartilage. Three small circles are marked on the cricoid cartilage to guide and help trainees to correctly place their fingers on the cricoid cartilage during application of the recommended force. Repeated training allow the trainee to reproduce the correct force in clinical practice.

### BRIEF DESCRIPTION OF THE DRAWINGS

A specific embodiment of the invention will now be described, by way of example only, with reference to the accompanying drawings that follow, in which:

FIG. 1 is a schematic diagram showing the two boxes and the scale.

FIG. 2 shows the position of the calibrated spring and the scale inside the small box.

FIG. 3 shows the whole device including the sponge, the diagram of the cricoid cartilage and the points of placement of the fingers.

### DESCRIPTION OF THE PREFERRED EMBODIMENTS

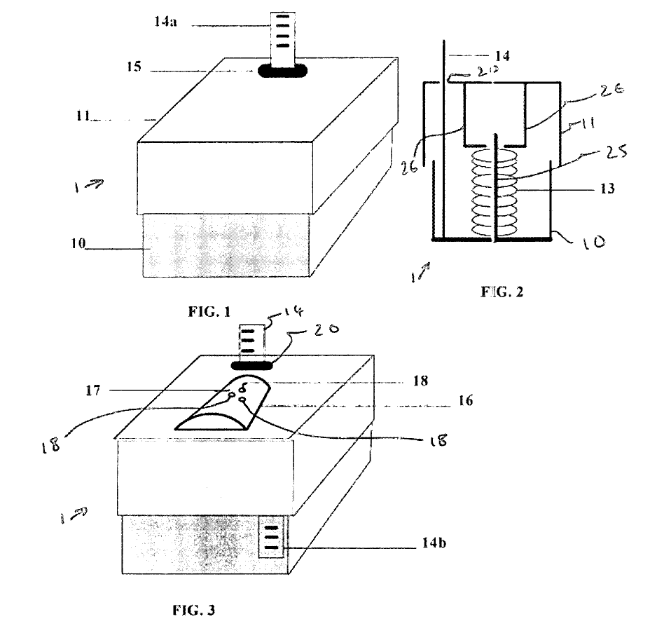

As shown in FIGS. 1 to 3, a device 1 for use in training an operative in the reproduction of a desired force intended to be applied to the cricoid cartilage of a patient undergoing tracheal intubation comprises force measuring means comprising a first member 10 and a second member 11 which are movable relative to each other. In particular, the first lower member 10 and the second (upper) member 11 have resilient means 13 located therebetween. The resilient means 13 comprises a spring 13 and, in particular, a calibrated spring 13 which maintains an inner (lower) surface of the first lower member 10 spaced from the (upper) inner surface of the second (upper) member 11 by a predetermined distance, at rest

In particular, the calibrated spring 13 may abut the inner surface of the lower box member 10 and projects upwardly therefrom.

The device 1 may comprise retaining means to retain the calibrated spring 13 in an upwardly extending vertical position. The retaining means may comprise a rod 25 which locates within the passageway defined in the helical calibrated spring 13. The upper box member 11 includes a downwardly extending projection(s) 26 from the inner surface thereof. The downwardly extending projections 26 are arranged to abut the upper end of the spring 13.

The force measuring means comprises a scale 14 which indicates the relative separation distance of the first member 10 and the second member 11. The scale 14 includes force display means which indicates or displays the force being applied to the second (upper) member 11. In use, the device is located on a rigid, hard surface. Once a force is applied to the second (upper) member 11, the force will move the second (upper) member 11 downwardly towards the first (lower) member 10. As the force is increased the relative separation distance between the two members 10, 11 will decrease indicating a greater force applied.

The scale 14 is statically secured to one of the members 10, 11 and a part of the other member 10, 11 thereby moves relative to the scale 14 which thereby indicates the force.

The force measuring means can be quickly and easily calibrated such that the force can be quickly and easily read and monitored without the need for any electrical equipment.

Accordingly, the present invention is cheap and can be used in many difference locations. Furthermore, the present invention is small and portable and, again, can be used by many different people without the restrictions of complicated and expensive devices.

In one embodiment, the scale 14 comprises an elongate member which extends upwardly from an inner surface of the lower member 10. The elongate scale member 14 extends through an aperture 20 provided in the upper member 11 and, accordingly the length of the elongate scale 14 extending upwardly from the upper surface of the upper member 11 indicates and measures the force applied.

In another embodiment, the scale 14b may be secured to an outer side (external) surface of the lower member 10. Again, the position of the upper member 11 or at least part of the upper member 11 located adjacent to the scale 14b relative to this scale 14b indicates the force applied.

The device 1 comprises a simulated throat and/or neck portion 16 located on an upper surface of the upper member 11. The simulated throat or neck portion 16 comprises a resilient material in order to simulate the resilient properties and feel of a throat/neck portion 16. In one embodiment, the simulated throat/neck portion 16 comprises a section of sponge 16 and more preferably a part of a cylindrical section of sponge 16.

The simulated throat/neck portion 16 also comprises a simulated cricoid cartilage. The simulated cricoid cartilage comprises a rigid member which may simulate the shape and/or feel of the cricoid cartilage and is located within the simulated throat/neck portion 16. The simulated cricoid cartilage is not visible but can be felt by the operative.

The device also comprises an indicator or a display 17 of a (simulated) larynx to indicate the location of the larynx on the simulated neck portion. The position of the larynx relative to the simulated cricoid cartilage is provided by the visual indicator 17 and specifically a printed diagram of the larynx on the simulated neck/throat 16. The indicator is preferably adhered to the simulated neck/throat 16. In one embodiment, a single diagram showing the digit indicators and the larynx location is secured or adhered to the simulated neck.

The simulated throat/neck portion 16 also comprises indication means comprising visual indicators to indicate the correct placement or location of the digits required of the operative during application of the applied cricoid force. The indicators 18 comprise circular or other suitable shaped indicators to indicate the correct position of the index finger, middle finger and thumb of the operative relative to the simulated cricoid cartilage and/or larynx during application of the cricoid force. Accordingly, the digit indicators teach and train the correct position of the fingers and enable the operative to visually easily see the correct digit location. This trains them into remembering the correct location rather than by a more “hit and miss” system in which the correct digit location may not be readily or easily monitored. The present invention will immediately show if one or more digit is incorrectly located and in which direction and such incorrect location is readily and easily remedied rather than through trial and error. This may enable the operative to concentrate more on applying the correct force rather than worrying and overly thinking about the location of the digits.

The two members 10, 11 comprise boxes having a single open face. The lower member 10 is arranged to have an upper open face whereas the upper member 11 is arranged to have a lower open face. The dimensions or planar area of the upper box member 11 are greater then the dimension or planar area of the lower box member 10 and enable the lower box member 10 to move at least particularly into and out of the volume or interior of the upper box member 11. The upper box member 11 comprises an upper surface and a peripheral skirt which locates around the peripheral wall of the lower box member.

Again, referring to the drawings the device consists of 2 empty boxes made of plastic or any other suitable material. One box 10 is small and the second one 11 is large as shown in FIG. 1. The large box is placed over the small box so that it is supported by a calibrated spring 13 that is fixed to the bottom of the small box as shown in FIG. 2. The dimensions of the large (top) box are 10 cm×15 cm×10 cm and those of the small (bottom) box are 9.8 cm×14.8 cm×12 cm. One end of a plastic numerical scale 14a is fixed to the bottom of the small box, the other end overlies an opening 15 made in the large box as shown in FIGS. 1 and 2. The scale is flush with surface of the top box but protrudes out through the opening on this box when pressure is applied manually to the top box. Alternatively, the scale could be made by marking its graduation on the side of the bottom box 14b as shown in FIG. 3.

A cylindrical sponge 16 (dimensions are 7 cm diameter×10 cm long) is fixed to the top box to simulate the neck as shown in FIG. 3. A small piece of wood is inserted inside the sponge and fixed to the top box to mimic the cricoid cartilage. A printed diagram of the larynx 17 is glued to the sponge and three finger imprints 18 are marked on the diagram to indicate the correct position for placement of the fingers during application of the cricoid force as shown in FIG. 3. When pressure is applied on the top box, the spring is compressed and the scale (graduated 0-30 Newton) protrudes outside the top box to indicate the applied force. Regular training on the device allows medical personnel to reproduce the recommended force when this is needed during emergency anaesthesia.

The training device assists medical personnel in the correct application of the cricoid force/pressure during emergency anaesthesia is described. The device comprises 2 plastic boxes, a calibrated spring and a numerical scale to monitor the applied force/pressure, a sponge or any other suitable material which simulate the neck to which is attached a printed diagram of the larynx and the cricoid cartilage plus circular marks to dictate where the fingers should be placed for application of the pressure/force.

The training device allows trainees to practice the correct application of cricoid force/pressure wherein, using three fingers, pressure/force is applied on a simulated neck glued to a plastic box and monitoring means of the applied force is provided by means of a calibrated spring and a numerical scale.

The training device for the application of the correct cricoid force/pressure includes a simulated neck/throat wherein the neck size and feel is simulated with a sponge or any other suitable material.

The training device for the correct application of cricoid force/pressure includes a simulated cricoid cartilage wherein the cricoid cartilage is simulated by a small piece of wood or any suitable material placed inside the sponge.

The training device for the correct application of cricoid force/pressure includes a larynx position indicator wherein a diagram of the larynx with circular imprints is glued to the sponge to dictate the exact locations for placement of the fingers during application of cricoid force.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A device for use in training an operative in the reproduction of a desired force intended to be applied to the cricoid cartilage of a patient undergoing tracheal intubation, the device comprising a simulation of at least part of a neck, the device including force measuring means for measuring the force applied to the simulated neck, the device further comprising display means to display the location of a larynx on the simulated neck, the device further comprising indication means to indicate the correct location on the simulated neck of the digits of the operative relative to the displayed larynx whilst applying the force to the cricoid cartilage.

2. A device according to claim 1 in which the force measuring means comprises a first member and a second member which are connected to each other by resilient means.

3. A device according to claim 2 in which the resilient means comprises a calibrated spring.

4. A device according to claim 2 in which the resilient means locates between an inner surface of the first member and an inner surface of the second member.

5. A device according to claim 2 in which either the first member or the second member includes a scale which indicates the force applied.

6. A device according to claim 5 in which the scale is secured to the first member and extends upwardly and above the second member.

7. A device according to claim 6 in which the scale locates upwardly from an inner surface of the first member and extends through an aperture provided in the second member.

8. A device according to claim 5 in which the scale is secured to or displayed on an external side wall of the first member.

9. A device according to claim 8 in which a part of the second member is arranged to locate adjacent to the scale in order to indicate the force applied.

10. A device according to claim 2 in which the first member and the second member form a box having an upper surface and a lower surface wherein the upper surface is movable relative to the lower surface.

11. A device according to preceding claim 1 in which the indication means includes a first indicator to indicate the correct position of a first digit of the operative relative to the displayed larynx, whilst applying pressure.

12. A device according to claim 11 in which the indication means includes a second indicator to indicate the correct position of a second digit of the operative relative to the displayed larynx, whilst applying pressure.

13. A device according to claim 12 in which the indication means includes a third indicator to indicate the correct position of a third digit of the operative relative to the displayed larynx, whilst applying pressure.

14. A device according to claim 11 in which the indicator comprises a visual indicator.

15. A device according to claim 14 in which the indicator comprises a circular mark or a finger tip/print shaped mark for each relevant digit.

16. A device according to claim 1 in which the simulated neck comprises a resilient material.

17. A device according to claim 16 in which the simulated neck comprises a sponge material.

18. A device according to claim 2 wherein the second member has an upper surface and in which the simulated neck is adhered to the upper surface of the second member.

19. A device according to claim 1 in which the device further comprises a simulated cricoid cartilage.

20. A device according to claim 19 in which the simulated cricoid cartilage is located within the simulated neck.

21. A device according to claim 19 in which the simulated cricoid cartilage comprises a substantially rigid material.

22. A device according to claim 1 in which the displayed larynx comprises a visual indicator of the position of the larynx on the simulated neck.

23. A method of training an operative in the technique of applied cricoid force, the method comprising providing indicator means on a simulation of part of a neck to indicate the correct position of at least one digit of the operative relative to a simulated larynx on the simulated neck whilst applying pressure, the method further comprising measuring the force applied.

24-25. (canceled)
